(19) United States
(12) Patent Application Publication
(10) Pub. No.: US 2010/0082467 A1
(43) Pub. Date: Apr. 1, 2010

(54) PHONE AND METHOD OF USING THE PHONE FOR BENEFICIARY INITIATED PAYMENTS

(76) Inventors: Mark Carlson, Half Moon Bay, CA (US); Surendra Keshan, Cupertino, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/425,250

(22) Filed: Apr. 16, 2009

Related U.S. Application Data
(60) Provisional application No. 61/100,595, filed on Sep. 26, 2008.

(51) Int. Cl. G06Q 20/00; G06Q 40/00; G06Q 30/00; H04M 15/00

(52) U.S. Cl. 705/34; 705/40; 705/41; 379/114.03

(57) ABSTRACT

A phone containing a data bearing medium and a method of using that phone to allow a Payee to request payment from a Payor is disclosed. The data bearing medium contains instructions to direct the phone to enable the Payee to issue an invoice in electronic form detailing the payment request to the Payor. The phone further allows the Payor to pay the invoice using a suitable payment means, such as a credit card, without requiring any infrastructure investment on the part of the Payee. Finally, the phone does not require that the Payee receive funds from the Payor in a specific account. The phone allows the Payee to receive their funds in any account specified by the Payee.

### CROSS REFERENCES TO RELATED APPLICATIONS

This application is a non-provisional of and claims the benefit of U.S. Patent Application No. 61/100,595 (Attorney Docket 16222U-039800US) filed on Sep. 26, 2008. This application is also related to U.S. patent application Ser. No. 11/______ (Attorney Docket 16222U-039810US) filed on or about the same date as the present application. Both of these applications are herein incorporated by reference in their entirety for all purposes.

### BACKGROUND

There are many situations in which a person or entity (“Payee”) wishes to request money from another person or entity (“Payor”). In the simplest situation, the Payee may make a verbal request to the Payor, and physically receive funds from the Payor. In more complicated situations, the request involves the issuance of an invoice by the Payee to the Payor. The invoice will typically contain details regarding the specific reasons that money is being requested, such as for goods delivered or services rendered. The Payee will send the invoice to the Payor through a means such as the US Mail. The Payor will then typically send funds to the Payee through means such as sending a written check, money order, or cash.

The process of issuing an invoice to a Payor and receiving funds from the Payor that is described above suffers from several shortcomings. The Payee typically must wait for the Payor to receive the invoice and send payment. Furthermore, in cases where payment is made through a written instrument such as a check, the Payee is not guaranteed that the payment instrument is valid (e.g. bounced check). In addition, even if the written instrument is valid or cash is received, the payment still must be deposited by the Payee into a checking or savings account, thus further delaying the availability of the funds in the account for further transactions. Additionally, the Payee will typically have no means for depositing funds received from a Payor directly into an account associated with a credit card, thus requiring a two step process of depositing funds into a banking account, then sending the funds to a credit card account through a means such as writing a check.

The process further suffers from the fact that payments can typically only be made through the use of cash or a written instrument, such as a check. In many situations, the Payor may not have sufficient funds to directly pay the amount owed, but will have access to a line of credit, such as from a credit card, from which to pay. It is generally not a straightforward or inexpensive process for a Payee to establish the necessary infrastructure for receiving credit card payments directly. It makes even less sense for a Payee to spend the time and expense to establish such facilities when the number of transactions to be processed is small or possibly even a one off transaction.

In addition to the problems mentioned above, the process further suffers from the delays associated with sending invoices and receiving payment. Typically, a facility such as the US Mail may be used to transfer invoices and payments. In today's world of nearly instantaneous electronic communication, such a delay is almost intolerable.

There have been attempts at solving the above mentioned problems. One example of such an attempt is the system offered by PayPal™. That system allows a Payee to issue an invoice to a Payor through the use of e-mail. The Payor will receive the e-mailed invoice, and pay the amount due through the use of a bank account or credit card. The funds are retrieved from the Payor's account at a banking or credit card institution, and deposited into an account at the PayPal™ system that is associated with the Payee. The Payee may have a debit card issued corresponding to their account, which can then be used to perform additional transactions.

Although the PayPal™ system does solve some of the problems associated with issuing an invoice and receiving payment, other problems still remain. For example, in order to use the PayPal™ system, a Payee is required to register with the system. This can be a problem for any number of reasons, the simplest being that a Payee may not wish to register for privacy reasons. Additionally, a Payee may only receive funds in their PayPal™ account, and as such is tied to maintaining a financial account at the PayPal™ system. This may be undesirable for any number of reasons, an example of which could be that the PayPal™ account does not provide for an interest rate on funds held that is acceptable to the Payee. In any case, the Payee is locked into receiving their funds into their PayPal™ account. Furthermore, although PayPal™ does provide a feature whereby a Payee can manually initiate an electronic transfer of funds from their PayPal™ account to a checking or savings account, it does not provide a facility to directly transfer funds, either automatically or manually, to a credit card account.

A system that allows a Payee to request payment from a Payor would be desirable. Such a system would desirably allow the Payee to issue an invoice in electronic form detailing the payment request to the Payor. The system would also desirably allow the Payor to pay the invoice using a suitable payment means, such as a credit card, without requiring any infrastructure investment on the part of the Payee. Finally, the system would desirably not require that the Payee receive funds from the Payor in a specific account that is associated with the system. The system would desirably allow the Payee to receive his funds in any account specified by the Payee.

Embodiments of this disclosure address these and other problems individually and collectively.

### BRIEF SUMMARY

Embodiments of the present disclosure pertain to methods and systems for issuing an electronic invoice and receiving payment of the invoice, where the payment is deposited into an account that is specified by the recipient.

In one embodiment of the invention, a method of issuing an invoice and receiving payment is described. The method includes receiving from a first user's phone an invoice requesting a payment from a second user, wherein the invoice contains contact information for the second user's phone. The method further includes sending the invoice to the second user's phone, wherein sending the invoice includes providing instructions for paying the invoice using a transaction account associated with the second user. The method further includes requesting funds from an issuer of the transaction account associated with the second user, wherein the funds are drawn from an account associated with the second user's transaction account, and then receiving funds from the issuer of the transaction account associated with the second user. The method also includes transferring the received funds to an issuer of a transaction account specified by the first user, wherein the funds are deposited to the transaction account specified by the first user. The method can further include allowing the first user to register as an ad hoc user, which does not require permanently storing the first user's identifying information. The method can further include erasing all information related to the transaction once the transaction has been completed.

Another embodiment of the invention is directed toward a payment processing network used for issuing an invoice and receiving payment. The payment processing network is configured for use with a first phone. The first phone is configured to generate an invoice containing contact information for a recipient of the invoice and send the invoice to the payment processing network. The payment processing network is also configured for use with a second phone. The second phone is configured to receive an invoice requesting payment and send a response with payment instructions to the payment processing network. The payment processing network is further configured to receive the invoice from the first phone and send the invoice to the second phone. The payment processing network is also configured to receive payment instructions from the second phone and retrieve funds from an account associated with the second phone. The payment processing network is further configured to deposit the funds into an account associated with the first phone.

In yet another embodiment of the invention, a method performed by a first phone is described. The method includes generating an invoice, wherein the invoice contains contact information for a recipient of the invoice. The method further includes sending the invoice to a payment processing network, wherein the payment processing network is configured to receive the invoice from the first phone. The payment processing network is further configured to send the invoice to a second phone. The payment processing network is also configured to receive payment instructions from the second phone. The payment processing network is further configured to retrieve funds from an account associated with the second phone. The payment processing network is also configured to deposit those funds into an account associated with the first phone.

In yet another embodiment of the invention, a first phone is described. The first phone contains a processor, an antennae coupled to the processor, a microphone coupled to the processor, and a computer readable medium coupled to the processor. The computer readable medium contains code for generating an invoice, wherein the invoice contains contact information for a recipient of the invoice. The computer readable medium also contains code for sending the invoice to a payment processing network, wherein the payment processing network is configured to receive the invoice from the first phone and send the invoice to a second access device. The payment processing network is further configured to receive payment instructions from the second access device and retrieve funds from an account associated with the second access device. The payment processing network is also configured to deposit the funds into an account associated with the first phone. In some embodiments, the second access device can also be a phone.

These and other embodiments of the invention are described in detail below.

### BRIEF DESCRIPTION OF THE DRAWINGS

The disclosure, together with further advantages thereof, may best be understood by reference to the following description taken in conjunction with the accompanying drawings in which:

FIG. 1 is a high level diagram illustrating one embodiment of a system in accordance with the present disclosure.

FIG. 2 is a high-level flow diagram illustrating one embodiment of a method of processing a payment transaction in accordance with the present disclosure.

FIG. 3(A-E) depicts exemplary screen shoots according to one embodiment of the system of the present disclosure.

FIG. 4 shows a block diagram of a computer apparatus.

FIG. 5 shows a block diagram of a network access device.

### DETAILED DESCRIPTION

Embodiments of the present disclosure pertain to methods and systems for issuing an electronic invoice and receiving payment of the invoice, where the payment is deposited into an account that is specified by the recipient.

In certain embodiments of the invention, a user (“Payee”) may wish to request money from another user (“Payor”). The Payee may wish to receive the money in the form of a deposit to an account that has been provided by an account issuer. As used herein, a “deposit” may include an actual transfer of money to an account such as a debit card account, or may include a debit to an account such as a credit card account. There are many different types of accounts that can be issued, such as credit card accounts, debit card accounts, pre-paid card accounts, and gift card accounts. Generically, these accounts may be referred to as transaction accounts, because they will typically provide the Payee with the ability to use the account to engage in financial transactions. This is generally accomplished through the issuance of a transaction card that is associated with the transaction account. Transaction cards can take many forms, including plastic cards with a magnetic stripe, smartcards, elements embedded in cellular phones, secure tokens, or any other suitable form. In other situations, the Payee may only have an account number which identifies the transaction account and can be used to perform transactions.

In many cases, the Payee may have multiple transaction accounts that have been issued by multiple issuers. An issuer is a financial institution, generally a bank, that creates and maintains financial accounts. Unlike traditional bank accounts, such as checking and savings accounts, it is typically not possible for anyone other than the owner or authorized user of a transaction account to make deposits into the transaction account. As an example, it is typically not possible for anyone other than the owner or authorized user of a credit card to make payments to the account associated with the credit card. This may be for the simple reason that to allow a third party to make a payment to a credit card would require revealing the account information, such as the credit card number, to the third party.

In an embodiment of the invention, a Payee requesting funds from a Payor may wish to send the Payor an invoice detailing the reasons why a payment is being requested. The invoice may provide details such as items sold or services rendered. In other embodiments the invoice may simply request a payment of an amount without providing specific details. Embodiments of the present invention can allow a Payor to issue a request for payment to a Payee in the form of an invoice that is sent electronically to the Payor. In some embodiments, the Payee may specify contact information for the Payor which can be used to send the electronic invoice. One example of such contact information is an e-mail address. Other examples include instant messaging addresses, phone numbers, pager numbers, IP addresses, and the like. Any means of communication suitable to provide an electronic invoice to a Payor can be used.

Embodiments of the present invention further allow a Payee to register as an ad hoc user of the system. An ad hoc user of the system is not required to maintain an account on the system and the information provided to the system may be used for a single transaction only. For example, a Payee may register with the system as an ad hoc user and specify a transaction account to receive the funds that will be requested. Once the transaction is complete, and the funds have been received, the system can remove all of the information regarding the transaction, including from whom payment was requested, the contents of the invoice sent, and the transaction account into which funds were deposited. This provides the Payee with an increased level of security and privacy because any of the information regarding the transaction is only stored as long as necessary to complete the transaction. Furthermore, as mentioned above, the Payee may have multiple transaction accounts and allowing a user to specify the account to receive funds on a per transaction basis allows the Payee to switch accounts that will receive funds at will. In other embodiments of the invention, the system will store the Payee's transaction account details in order to provide additional convenience to the user, as they will not have to specify the account to receive funds for each transaction.

In addition to the improvements in security and privacy mentioned above, embodiments of the present invention provide the user with increased flexibility with respect to the transaction account that is used to receive funds. As will be discussed in further detail below, embodiments of the system in the present invention are not tied to any given transaction account. As such, payments can be received in any transaction account specified by the Payee. This allows the Payee to freely obtain new accounts and discard old accounts with out losing the ability to request payments. Unlike the systems of the prior art, where the mechanism to request payment is tied with the account to receive payments, embodiments of the present invention do not suffer from this fixed relationship.

Once a Payee has registered as an ad hoc user, prepared an invoice to be sent to a Payor, and provided contact information for the Payor, the system can send the invoice to the Payor. In one embodiment, this invoice may be sent via an e-mail to the Payor. In some embodiments the e-mail may further include instructions, such as a clickable link, that will allow the Payor to pay the invoice. The Payor may be presented with an option to pay the invoice using a transaction account issued to the Payor. An example of such an account could be a credit card account, a debit card account, a gift card account, or the like. After the Payor has specified the transaction account to be used to pay the transaction, the information can be sent to the payment processing network of the present invention.

Embodiments of the present invention include a payment processing network. The payment processing network is configured to request transaction authorization from issuers of transaction accounts, retrieve funds from those issuers and hold them temporarily, and deposit those funds into other transaction accounts. The payment processing network is capable of directly receiving funds from issuers and transferring those funds to other issuers because the payment processing network is typically connected in a secure manner to the issuer systems. The payment processing network may include a server computer comprising a processor, and a computer readable medium comprising code for performing these functions. Because the payment processing network is directly involved in the authorization, settlement, and clearing of transaction account transactions, it has the ability to directly pull funds from, for example, a Payor's credit card account. Furthermore, for the same reasons, the payment processing system has the ability to directly push those funds into the transaction account of a Payee.

The ability to directly pull funds from a transaction account and push those funds into another account provides for several advantages over the prior art systems. As has been mentioned above, the payment processing network can pull funds from any transaction account, and can push those funds into any other transaction account. As such, unlike the system provided by PayPal™, the Payee is not limited to using an account that is tied to the provider of the invoicing facilities. Furthermore, the ability to push funds into any account allows for payments to be received in a transaction account that would normally not be able to receive payments from a third party. For example, a Payor would not be able to send funds directly to the transaction account specified by the Payee, because it would be undesirable for the Payee to reveal the account information. In embodiments of the present invention, such a deposit can be made without any information being revealed to the Payor.

After receiving the transaction account information from the Payor, the payment processing network can pull funds directly from the issuer of the transaction account specified by the Payor. In one embodiment, those funds can be temporarily held in a generic holding account established at the payment processing network to hold all funds that have not yet been designated to be pushed into other accounts. In other embodiments, the funds may be held in an account established for the issuer that holds the accounts where the funds will be pushed. In either case, the pulled funds can be temporarily held prior to being deposited into the transaction account associated with the Payee.

Once the funds are available in the temporary holding account at the payment processing network, the payment processing network can push those funds into the transaction account that was originally specified by the Payee. As has been mentioned previously, because the payment processing network is not tied to any individual issuer or transaction account, funds can be pushed into any account specified by the Payee.

In an embodiment of the invention, after the funds have been pushed into the transaction account specified by the Payee, a notification may be sent to the Payee. This notification may alert the Payee that the funds have been deposited into the specified account, and that the transaction is complete. In one embodiment, the notification may be in the form of an e-mail to the Payee. In other embodiments, the notification may be an instant message, a telephone message, a pager message, or the like. Furthermore, in some embodiments, after the transaction is complete, all records of the transaction may be purged from the system in order to provide an additional measure of security and privacy to both the Payor and the Payee.

Embodiments of the present invention will now be described in detail with reference to exemplary embodiments as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

I. Exemplary Systems

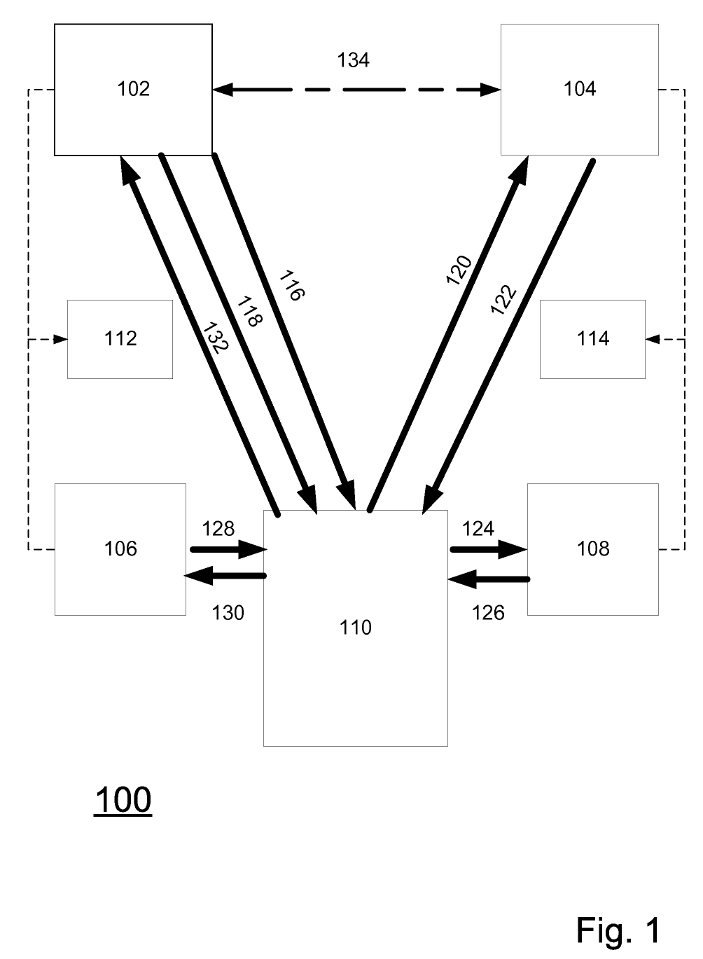

FIG. 1 is a high level diagram illustrating one embodiment of a system 100 capable of performing the disclosed method. The system 100 includes a Payee access device 102, a Payor Access Device 104, account issuers 106, 108, and a payment processing network 110. The components illustrated in FIG. 1 and recited above can be in operative communication with each other. The system 100 can further optionally include transaction cards 112, 114 issued by the issuers 106, 108 to the users of the Payee access device 102 and the Payor access device 104 and associated with accounts maintained by the issuers for the Payor and Payee respectively.

The access devices 102, 104 according to embodiments of the system can be in any suitable form. Any access device that is capable of sending information to and receiving information from a payment processing network would be suitable. One exemplary access device could be a personal computer. Other examples of access devices could include cellular phones, Personal Digital Assistants (PDA), Pagers, and the like. The access device may contain a computer readable medium. The computer readable medium may embody a program containing code to perform embodiments of the invention. The access device may communicate with the payment processing network through any suitable communications channel. One exemplary communications channel could be communications through the Internet. Other examples of a communications channel could include wired and wireless networks or local and wide area networks.

The payment processing network 110 may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 110 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 110 may use any suitable wired or wireless network, including the Internet.

The account issuers 112, 114 may be any type of financial institutions, such as banks, that issue transaction accounts. Such accounts can include credit accounts, debit accounts, and banking accounts, such as checking and savings accounts. An account issued by an account issuer 106, 108 may optionally be associated with a transaction card 112, 114 that is issued to the users of the transaction account. Transaction cards 112, 114 may be credit cards, debit cards, or any other type of payment card. The cards may be in any suitable form, such as a card that maintains data in a magnetic stripe on the card, a smartcard, or the like. A transaction card 112, 114 may be issued to the users of the transaction accounts for use in performing in person transactions. However, a physical transaction card 112, 114 is not necessary in embodiments of this system.

Although FIG. 1 depicts a single issuer 106 associated with a single Payee 102 with a single transaction card 112, it would be clear to a person of skill in the art that this is not limiting. A Payee 102 may have any number of transaction accounts, issued by any number of issuers. Likewise, a Payor 104 may have any number of transaction accounts, issued by any number of issuers. Issuers 106, 108 may likewise issue transaction accounts to any number of users. In some embodiments, the Payor 102 and Payee 104 may both have transaction accounts issued by the same issuer.

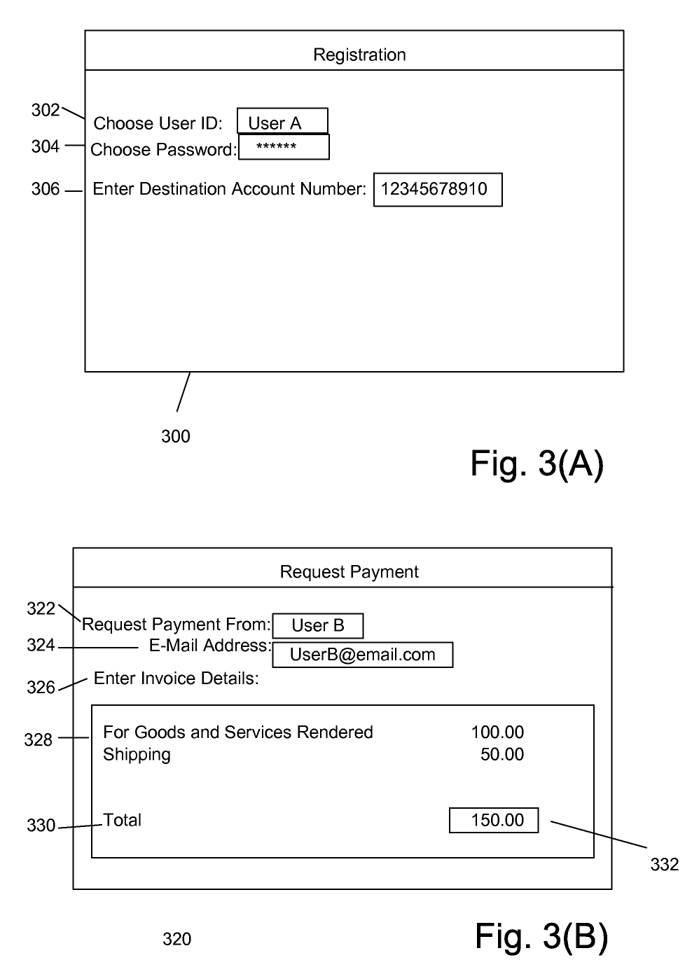

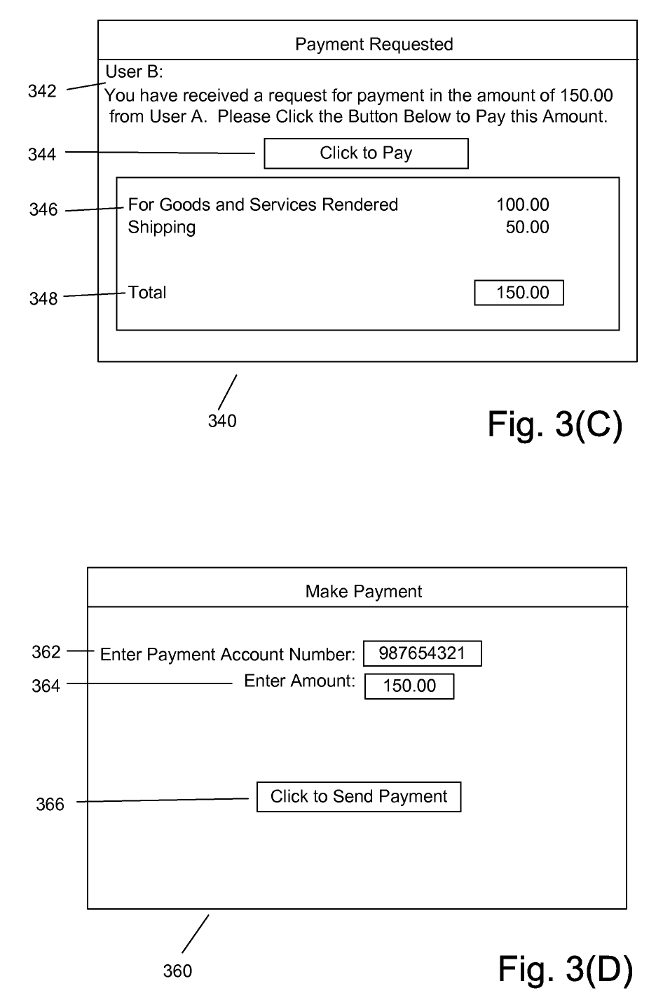

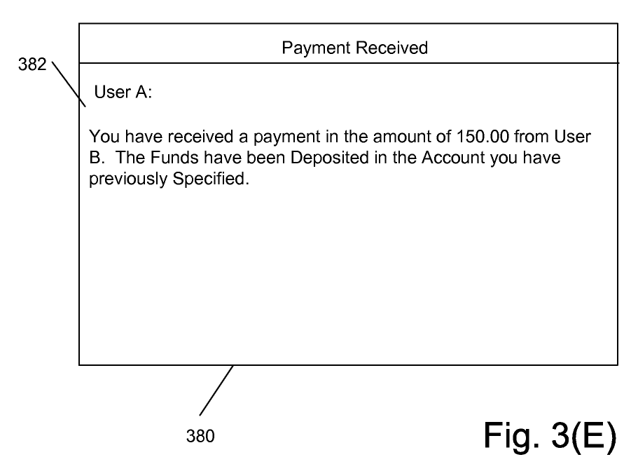

In order to request and receive a payment, a Payee may submit an ad hoc registration request 116 to the payment processing network 110. In some embodiments of the system, the registration request 116 is not permanently stored by the payment processing network 110, and is only maintained long enough for the transaction to be processed. The ad hoc registration request may include information such as a user name for the user of the Payee access device 102 and an identifier of the transaction account that the Payee wishes to have the received funds deposited into. The transaction account can be associated with an issuer 106 Because the registration information may specify the account into which funds should be deposited, it would be clear to one of skill in the art that the Payee 102 may specify different accounts to use for every transaction. The Payee is not limited to a single account associated with a single issuer 112. An exemplary screen shot of such an ad hoc registration is shown in FIG. 3(A).

A Payee may further create and submit 118 an invoice to the payment processing network 110. The invoice may contain information describing why payment is being requested, such as for items sold, or services rendered. The invoice may also contain a total amount due. The invoice may further contain contact information for the Payor. In some embodiments, Payor contact information is an e-mail address. In other embodiments, the contact information may be an instant messaging address, a phone number, or the like. Any suitable means for communicating with the Payor may be used. An exemplary screen shot of such a Payment Request screen is shown in FIG. 3(B).

The Payment Processing Network 110 may receive the payment request 118, which contains the invoice and contact information for the Payor 104. The Payment processing network may then send the invoice along with instructions on how to pay the invoice 120 to the Payor 104. In one embodiment, the invoice may be sent to the Payor's 104 e-mail address. In other embodiments, the invoice may be sent to any suitable device, such as a cellular telephone, a personal digital assistant (PDA), a pager, or the like. An exemplary screen shot of such a Payment Requested screen is shown in FIG. 3(C).

The Payor may receive the payment request 120 at the Payor's access device 104. In one exemplary embodiment, the Payor may receive the payment request in an e-mail message. In other embodiments, the payment request may be received by any suitable device, such as a cellular telephone, a personal digital assistant (PDA), a pager, or the like. Contained in the payment request 120 may be the invoice that was created by the Payee, as well as instructions as to how the Payor may pay the invoice. In one embodiment, the e-mail may contain a link which may be clicked by the Payor to pay the invoice. Clicking on the link may take the Payor to a page that will allow the Payor to specify information about the account they wish to use to pay the invoice. In one embodiment, the account information may include an account number. The account information may specify any type of account that has been issued to the Payor by an issuer. Such accounts may include credit card accounts, debit card accounts, gift card accounts, and the like. In one embodiment, the Payor may specify the transaction account they wish to use based on a transaction card 114 that has been issued to the Payor 104 by an issuer 108. An exemplary screen shot of such a Make Payment screen is shown in FIG. 3(D).

After the Payor has specified the transaction account from which funds should be withdrawn to pay the invoice, the Payor may send this information 122 to the Payment Processing Network 110. The Payment Processing Network 110 may then receive the account information provided by the Payor, and determine the issuer that issued the transaction account. In one embodiment, the issuer can be determined based on the account number. The Payment Processing Network 110 may then request a transfer of funds 124 from the issuer 108 that has issued the Payor's transaction account. The Payment Processing System 110 is capable of requesting funds directly from the issuer because, as mentioned above, it contains payment authorization, clearing, and settlement services.

The Issuer 108 of the Payor's Transaction account may receive the request 124 for the transfer of funds from the Payor's transaction account. After verifying that the account is valid, and that sufficient funds or credit exists to make the payment, the Issuer 108 may respond 126 to the Payment Processing Network 110 indicating that the transaction may proceed.

Upon receipt of the message indicting that the transaction may proceed 126, the Payment Processing Network may withdraw funds from the Payor's transaction account. In one embodiment, the received funds may be temporarily stored in a generic holding account at the Payment Processing Network 110 prior to being transferred to the issuer of the Payee's account. In another embodiment, the funds may be temporarily stored in a holding account that is associated with the Issuer of the Payee's account, but not specifically associated with the Payee's account.

The Payment Processing Network 110 may then push the funds received from the Payor's transaction account into the account specified by the Payee in the Payment Request 118. The Payment Processing Network may send a message 128 to the Issuer 106 of the account specified by the Payee requesting that the funds received 126 be transferred from the account in which they are being held temporarily, into the account that the Payee has specified. Again, the Payment Processing Network 110 is capable of this transaction because it contains payment authorization, clearing, and settlement services. After the funds have been deposited into the account specified by the Payee, the Issuer 106 may send a response message 130 to the Payment Processing Network 110 indicating the successful transaction.

Upon receipt of the message 130 indicating a successful transaction, the Payment Processing System 110 may send a message 132 to the Payee indicating that the funds have been received and deposited into the specified account. An exemplary screen shot of such a Payment Received screen is shown in FIG. 3(E). At this point funds have been effectively transferred 134 from the Payor 104 to the Payee 102.

II. Exemplary Methods

A. Exemplary Process Flow

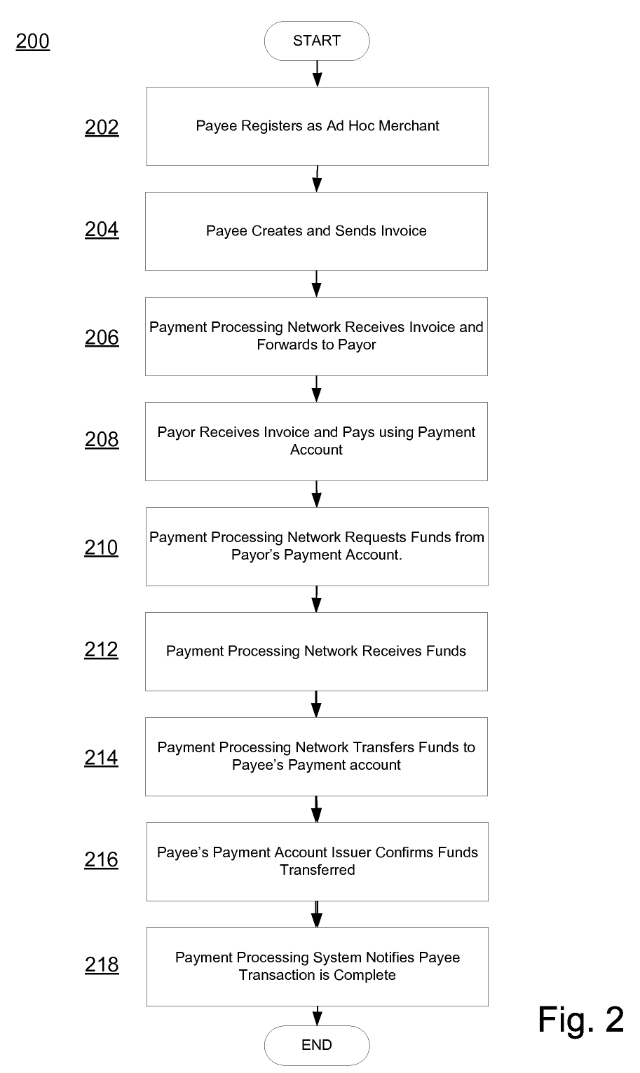

FIG. 2 is a high-level flow diagram illustrating one embodiment of a method of processing a payment transaction in accordance with the present disclosure. The method 200 may begin at step 202, wherein a Payee may register with the Payment Processing Network as an ad hoc merchant. In order to register, the Payee may provide information about the transaction account that received funds should be deposited to. The Payee may have multiple transaction accounts, and each request for payment may be designated to be deposited into a different transaction account.

The method may continue at step 204 wherein the Payee may create an invoice to request payment from a Payor. The invoice may contain details as to why a payment is being requested, such as for goods sold or services rendered. The invoice, along with contact information for the Payor, may then be sent to the Payment Processing Network. At step 206, the Payment Processing Network may receive the invoice and Contact information from the Payee and send the invoice along with payment instructions to the Payor. At step 208, the Payor may receive the invoice and follow the included payment instructions to pay the invoice. The Payor may provide the Payment Processing System with transaction account information such as an account number, which the Payment Processing System may use to identify the issuer of the transaction account.

At step 210, the Payment Processing Network may request funds from the issuer of the Payor's Transaction account. After receiving the request, the issuer of the Payor's transaction account may verify that sufficient funds or credit exists in the Payor's Transaction account. If sufficient funds or credit exist, the Payor's Transaction account Issuer may send the funds to the Payment Processing Network at step 212. The received funds may be temporarily held at the Payment Processing Network in an account that is not associated with any issuer. The funds may alternatively be held in an account that is associated with the issuer of the Payee's transaction account.

At step 214, the received funds may then be transferred from the account in which they were being held temporarily to the issuer of the transaction account that was specified in step 202. At step 216, the Payor's issuer may respond to the Payment Processing Network to confirm that the funds were received and deposited into the transaction account that was specified by the Payee in step 202. The method may end at step 218 wherein the Payment Processing Network may send a message to the Payee indicating that the invoice has been paid and the funds have been deposited into the account specified in step 202.

B. Exemplary User Interfaces

FIG. 3(A-E) depicts exemplary screen shots according to one embodiment of the system. FIG. 3(A) depicts an exemplary screen shot of a registration screen 300 that can allow a user to register to use the system and method, in order to request and receive payments. The user may select a user ID 302 which can be used to identify the user to both the system and to others who will send payments to the user. The user may also select a password 304 that will allow the system and the user to ensure that only authorized users are requesting payments. The user may further select a destination account 306, which can be the account where received funds will be deposited. Although the exemplary screen shots only depict a single destination account, it would be clear to one of skill in the art that any number of destination accounts may be specified, thus allowing the user to choose which account funds are to be deposited to, on a per transaction basis.

FIG. 3(B) depicts an exemplary screen shot of a Payment Request screen 320. A user may request a payment by specifying the entity from which a payment should be requested 322. In the figure, payment is being requested from User B. Furthermore, the user can specify contact information for the entity that is being requested to pay 324. In this example, the contact information is an E-mail address 324. It would be clear to one of skill in the art that an e-mail address is only one example of contact information. Other examples could be telephone numbers, pager numbers, instant messaging accounts, and the like. The payment request screen may also allow a user to enter invoice details 326. Invoice details 328 can include information such as why payment is being requested, goods that have been purchased, services that have been rendered, and the like. The total amount 330 requested can be specified by the user. In some embodiments, the system may calculate the total amount based on the invoice details 328.

FIG. 3(C) depicts an exemplary screen shot of a Payment Requested screen 340 that may be received by the entity from which payment is being requested. The page may include a brief description of the amount that is being requested, as well as who is requesting the payment 342. The payment requested screen 340 may also include a more detailed description 346 of the specific reasons why a payment is being requested. This detailed description 346 can include information such as why payment is being requested, goods that have been purchased, services that have been rendered, and the like. The information can be that which was entered by the party requesting payment, as depicted in 328. Furthermore, the Payment Requested Page 344 may include an instruction, such as a button to click 344 that can allow the invoice to be paid using a transaction card, a bank account, or any other source of funds. Making such a payment is depicted in FIG. 3(D).

FIG. 3(D) depicts an exemplary screen shot of a Make a Payment screen 360. This screen may allow the entity making a payment to enter an account number 362 from which to fund the payment. One example of an account number may be an account number associated with a transaction card, such as a credit card. One of ordinary skill in the art will recognize that any number of accounts, such as debit card accounts, checking accounts, savings accounts, and the like, in addition to credit card accounts may also be used to make a payment. The entity making a payment may be allowed to specify the amount to pay 364. In some embodiments the amount may be fixed to the amount that was requested 348 while in other embodiments, the Payor may make changes to the amount to be paid. The Make Payment screen may further include instructions, such as clicking a button to send payment 366, that will start the process of transferring funds from the Payor account to the Payee account.

FIG. 3(E) depicts an exemplary screen shot of a Payment Received screen 380. This screen may be displayed to the Payee when funds have been received from the Payor. The screen may alert the Payor that they have received funds from the Payee, and that the funds have been deposited into the account previously specified 382.

III. Exemplary System Elements

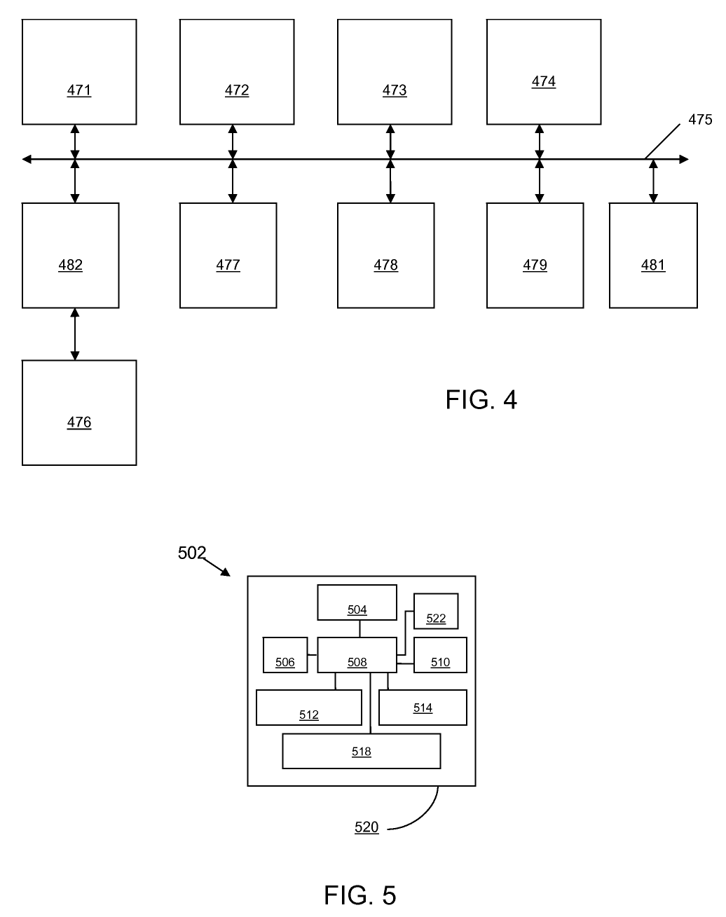

The various participants and elements in FIG. 1 may operate or use one or more computer apparatuses to facilitate the functions described herein. Any of the elements in FIG. 1 (e.g., the access devices 102, 104, the issuers 106, 108, the payment processing network 110, etc.) may use any suitable number of subsystems to facilitate the functions described herein. Examples of such subsystems or components are shown in FIG. 4. The subsystems shown in FIG. 4 are interconnected via a system bus 475. Additional subsystems such as a printer 474, keyboard 478, fixed disk 479 (or other memory comprising computer readable media), monitor 476, which is coupled to display adapter 482, and others are shown. Peripherals and input/output (I/O) devices, which couple to I/O controller 471, can be connected to the computer system by any number of means known in the art, such as serial port 477. For example, serial port 477 or external interface 481 can be used to connect the computer apparatus to a wide area network such as the Internet, a mouse input device, or a scanner. The interconnection via system bus allows the central processor 473 to communicate with each subsystem and to control the execution of instructions from system memory 472 or the fixed disk 479, as well as the exchange of information between subsystems. The system memory 472 and/or the fixed disk 479 may embody a computer readable medium.

In some embodiments, the computer readable medium may contain a program that includes code for generating an invoice, wherein the invoice contains contact information for the recipient of the invoice. The computer readable medium may also include code for sending the invoice to a payment processing network. The payment processing network can be configured to receive the invoice from a first access device and send it to a second access device. The payment processing network can also be configured to receive payment instructions from the second access device and retrieve funds from an account associated with the second access device. The payment processing network can further be configured to deposit the funds into an account associated with the first access device.

FIG. 5 shows block diagrams of portable access devices and subsystems that may be present in computer apparatuses in systems according to embodiments of the invention.

The portable wireless device that may be used in embodiments of the invention may be in any suitable form. For example, suitable portable wireless devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

An exemplary portable consumer device 502 in the form of a phone may comprise a computer readable medium and a body as shown in FIG. 5. FIG. 5 shows a number of components, and the portable wireless devices according to embodiments of the invention may comprise any suitable combination or subset of such components. The computer readable medium 506 may be present within the body 520, or may be detachable from it. The body 520 may be in the form a plastic substrate, housing, or other structure. The computer readable medium 506 may be a memory that stores data and may be in any suitable form including a magnetic stripe, a memory chip, encryption algorithms, private or private keys, etc. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. The computer readable medium 506 may also contain a program containing code for generating and sending an invoice as described above.

Information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable wireless device 502 may further include a contactless element 518, which is typically implemented in the form of a semiconductor chip (or other data storage element) with an associated wireless transfer (e.g., data transmission) element, such as an antenna. Contactless element 518 is associated with (e.g., embedded within) portable consumer device 502 and data or control instructions transmitted via a cellular network may be applied to contactless element 518 by means of a contactless element interface (not shown). The contactless element interface functions to permit the exchange of data and/or control instructions between the mobile device circuitry (and hence the cellular network) and an optional contactless element 518.

Contactless element 518 is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth, infra-red, or other data transfer capability that can be used to exchange data between the portable wireless device 502 and an interrogation device. Thus, the portable wireless device 502 is capable of communicating and transferring data and/or control instructions via both cellular network and near field communications capability.

The portable consumer device 502 may also include a processor 508 (e.g., a microprocessor) for processing the functions of the portable consumer device 502 and a display 510 to allow a consumer to see phone numbers and other information and messages. The portable wireless device 502 may further include input elements 512 to allow a consumer to input information into the device, a speaker 514 to allow the consumer to hear voice communication, music, etc., and a microphone 522 to allow the consumer to transmit her voice through the portable wireless device 502. The portable wireless device 502 may also include an antenna 504 for wireless data transfer (e.g., data transmission).

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Embodiments of the invention contain a number of advantages. A Payee that wishes to request funds from another person or entity may do so on an ad hoc basis, without being required to register for a service. The Payee may be able to issue invoices sent electronically to the Payor, thus reducing the time in transit for paper based communications. In embodiments of the invention, the Payor can receive an electronic invoice and may be able to pay the invoice using a credit card, which is an option that might not normally be available. In a similar fashion, embodiments of the invention can allow the Payee to accept credit card payments, without having to invest in any credit card processing infrastructure. In addition, embodiments of the invention do not require that the Payee maintain an account at a particular provider in order to utilize the invention. In some embodiments, the Payee could specify a different account to receive funds for every invoice issued.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A phone comprising:
a processor;
an antenna coupled to the processor;
a microphone coupled to the processor; and
a computer readable medium coupled to the processor, the computer readable medium comprising code for generating an invoice, wherein the invoice contains contact information for a recipient of the invoice, and code for sending the invoice to a payment processing network, wherein the payment processing network is configured to receive the invoice from the phone, send the invoice to a second access device, receive payment instructions from the second access device, retrieve funds from an account associated with the second access device, and deposit the funds into an account associated with the phone.

2. The phone of claim 1 wherein the second access device is a second phone.

3. The phone of claim 1 wherein the payment processing network is further configured to notify the phone after the deposit is completed.

4. A method of issuing an invoice and receiving payment comprising:
receiving from a first user's phone an invoice requesting a payment from a second user, wherein the invoice contains contact information for a second user's phone;
sending the invoice to the second user's phone, wherein sending the invoice includes providing instructions for paying the invoice using a transaction account associated with the second user;
requesting funds from an issuer of the transaction account associated with the second user, wherein the funds are drawn from an account associated with the second user's transaction account;
receiving funds from the issuer of the transaction account associated with the second user; and
transferring the received funds to an issuer of a transaction account specified by a first user, wherein the funds are deposited to the transaction account specified by the first user.

5. The method of claim 4 wherein the transaction account specified by the first user is specified when the invoice is received from the first user's phone.

6. The method of claim 4, wherein the transaction account associated with the first user is a credit card account.

7. The method of claim 5, wherein the credit card account is a pre-paid credit card account.

8. The method of claim 4, further comprising:
receiving an ad hoc registration request from the first user's phone; and
registering the first user as an ad hoc user.

9. The method of claim 4, further comprising notifying the first user's phone that payment of the invoice has been completed, wherein notification occurs when the funds have been deposited into the account specified by the first user.

10. The method of claim 4, further comprising:
receiving from the second user's phone authorization to pay the invoice with the transaction card associated with the second user.

11. The method of claim 4, further comprising erasing transaction related information after the transaction is completed.

12. A payment processing network for use with a
a first phone, wherein the first phone is configured to
generate an invoice, wherein the invoice contains contact information for a recipient of the invoice, and
send the invoice to the payment processing network, and
a second phone, wherein the second phone is configured to receive an invoice requesting payment, and
send a response with payment instructions to the payment processing network, and
the payment processing network is configured to:
receive the invoice from the first phone,
send the invoice to the second phone,
receive payment instructions from the second phone,
retrieve funds from an account associated with the second phone, and
deposit the funds into an account associated with the first phone.

13. The payment processing network of claim 12, wherein the invoice further includes account information specifying the account associated with the first phone.

14. The payment processing network of claim 12, wherein the payment processing network is further configured to hold the funds received from the account associated with the second phone in a holding account until the funds are deposited into the account associated with the first phone.

15. The payment processing network of claim 12, wherein the payment processing network is capable of clearing and settling credit and debit card transactions.

16. The payment processing network of claim 15, wherein the transaction cards are credit cards.

17. The payment processing network of claim 15, wherein the transaction cards are pre-paid credit cards.

18. A method performed by a first phone, the method comprising:
generating an invoice, wherein the invoice contains contact information for a recipient of the invoice; and
sending the invoice to a payment processing network, wherein the payment processing network is configured to
receive the invoice from the first phone,
send the invoice to a second phone,
receive payment instructions from the second phone,
retrieve funds from an account associated with the second phone, and
deposit the funds into an account associated with the first phone.
